(19) United States
(12) Patent Application Publication
(10) Pub. No.: US 2006/0154031 A1
(43) Pub. Date: Jul. 13, 2006

(54) Waterless tattoo

(76) Inventor: Brian Andrew Tomlinson, Toronto (CA)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/328,990

(22) Filed: Jan. 10, 2006

Related U.S. Application Data
(60) Provisional application No. 60/643,092, filed on Jan. 11, 2005.

(51) Int. Cl. B41M 5/00

(52) U.S. Cl. 428/195.1

(57) ABSTRACT

A tattoo that does not require water to be applied to a surface is described, as well as a method and apparatus for producing the tattoo. The tattoo comprises a base layer, a transfer coating adhered to the base layer, an ink layer adhered to the transfer coating, an adhesive layer adhered to the ink layer and a top layer adhered to the adhesive layer. The top layer is peelable off the adhesive layer and the base layer is peelable off the tattoo if the adhesive layer is pressed onto a surface. The tattoo can be produced on a printing press.

### RELATED APPLICATION

The present application claims the benefit of U.S. Provisional Application Ser. No. 60/643092 filed January 11, 2005 and which is hereby incorporated by reference in its entirety.

### FIELD OF THE INVENTION

This invention relates to temporary tattoos.

### BACKGROUND

Standard temporary tattoos use a waterslide material on a paper substrate. Waterslide tattoos use a water activated paper with a Dextrin coating as a base layer. The waterslide material will only transfer the ink of the tattoo to a surface when water has fully penetrated the waterslide material. When the water fully penetrates the coated paper, the ink is released from the based layer and an adhesive holds the tattoo onto a surface.

Temporary tattoos are normally given away in food packages, at restaurants, fairs, trade shows and sporting events. At most of these events, water and/or cloths are not available for use in transferring a waterslide tattoo. Waterslide tattoos need to be over wrapped if they are packaged with a food product, in order to keep the tattoo away from any moisture from the food product. For example, grease in a potato chip bag would activate a waterslide tattoo.

### SUMMARY OF THE INVENTION

In one aspect of the present invention, there is provided a tattoo comprising: a base layer; a transfer coating adhered to the base layer; an ink layer adhered to the transfer coating; an adhesive layer adhered to the ink layer; and a top layer adhered to the adhesive layer, the top layer being peelable off the adhesive layer and the base layer being peelable off the tattoo if the adhesive layer is pressed onto a surface.

In another aspect of the present invention, there is provided a method of producing a tattoo, the method comprising: applying a transfer coating to a base layer; applying an ink layer to the transfer coating; applying an adhesive layer to the ink layer; and applying a top layer to the adhesive layer such that the top layer can be peeled off the adhesive layer, the base layer being peelable off the tattoo if the adhesive layer is pressed onto a surface.

In another aspect of the present invention, there is provided a printing press for producing a tattoo: a transfer coating print station for applying a transfer coating to a base layer of the waterless tattoo, the transfer coating being peelable from the base layer; at least one ink print station for applying at least one ink layer to the transfer coating; an adhesive layer print station for applying an adhesive layer to the ink layer; and a top layer lamination station for applying a top layer to the adhesive layer, the top layer being peelable from the adhesive layer.

Tattoos made in accordance with embodiments of the present invention do not require water for application to a surface. An adhesive layer binds the tattoo to the surface and a transfer coating allows a base layer to be removed from the tattoo once the tattoo is affixed to the surface.

In embodiments of the present invention, ink is printed on a specially coated substrate which can be transferred without the use of water to skin or other surfaces. This waterless tattoo consists of a base layer which is coated with a transfer coating. The ink is printed on the coated base layer and an adhesive is applied to the ink. The ink and adhesive are covered by a top layer that serves as a protective layer. The tattoo is applied by removing the top layer and placing the adhesive layer against the surface. After pressure is applied, the base layer is removed leaving the ink on the surface.

Other aspects and features of the present invention will become apparent, to those ordinarily skilled in the art, upon review of the following description of the specific embodiments of the invention.

### BRIEF DESCRIPTION OF THE DRAWINGS

Exemplary embodiments of the invention will now be described in greater detail with reference to the accompanying drawings, in which:

FIG. 1 is a schematic showing the different layers of a tattoo in accordance with an embodiment of the present invention;

FIG. 2 is a flowchart of a method of producing a tattoo in accordance with an embodiment of the present invention;

FIG. 3 is a flowchart of a method of using a tattoo produced in accordance with an embodiment of the present invention; and

FIG. 4 is a schematic of a printing press for producing tattoos in accordance with an embodiment of the present invention.

### DETAILED DESCRIPTION OF THE PREFERRED EMBODIMENTS

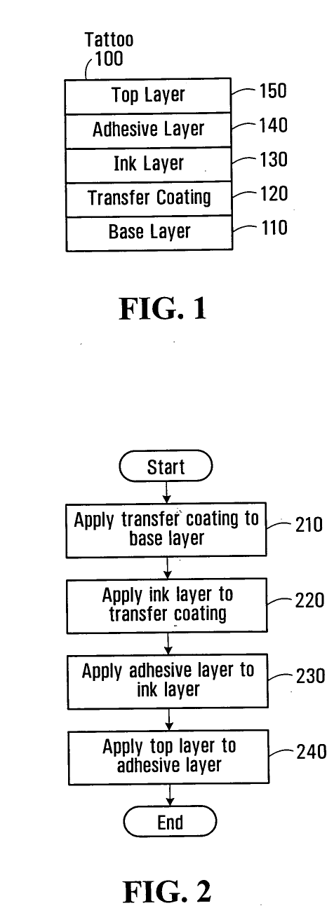

Referring to FIG. 1, a tattoo 100 according to one embodiment of the present invention, is comprised of five layers: a base layer 110; a transfer coating 120; an ink layer 130; an adhesive layer 140; and a top layer 150. The transfer coating 120 is releasably adhered to the base layer 120 and enables the base layer to be peeled off the tattoo once it is applied to a surface. The ink layer 130 is adhered to the transfer coating 120. In preferred embodiments, the ink layer 130 comprises an image. The adhesive layer 140 is adhered to the ink layer 130 and the top layer 150 is applied to the adhesive layer 140. The top layer 150 is peelable off the adhesive layer 140 and the base layer 110 peelable off the tattoo if the adhesive layer 140 is pressed onto a surface.

In some embodiments the ink layer 130 is made up of multiple ink layers of different colours resulting in a multi-colour image. The ink layer 130 may be comprised of, but is not limited to, flexography ink (either water based or solvent based), silk screen ink, offset ink or gravure ink.

In some embodiments the base layer 110 and the top layer 150 are made of film. In some embodiments the base layer 110 and the top layer 150 are made paper. The base layer 110 and the top layer 150 may be made of different materials. For example, the base layer 110 may be film and the top layer 150 may be paper.

The adhesive layer 140 works in combination with the transfer coating 120. The adhesive layer 140 “pulls” the ink layer 130 from the base layer 110 to the surface on which the tattoo 100 is applied. The transfer coating 120 enables the ink layer 130 to come off the base layer 110.

In some embodiments, the transfer coating 120 is a solvent based coating which has three main properties. The first property is that it provides a release between the ink layer and the base layer, thus meaning it is a temporary barrier between the two layers. Secondly, it provides a printable surface. As it is a coating, it helps with adhesion on surfaces to which ink would normally not adhere. Thirdly, it helps provide structural strength to the ink layer when the ink layer is separated from the base substrate. For example, in some embodiments, the transfer coating acts as a hardener and keeps the ink together when it is transferred.

A tattoo in accordance with embodiments of the present invention is useful as a temporary tattoo that can be removed immediately with rubbing alcohol or baby oil and/or that can wear off after a few days. If the tattoo is printed using silk screen ink on a silk screen press, the tattoos last an extra 2-3 days over flexographic ink.

Embodiments of the present invention allow a temporary tattoo to be transferred onto a surface, such as skin of a user, without the need for water. The tattoo is usable immediately upon receipt. Due to the transfer coating, the tattoo can be printed on both paper and film substrates by providing a treated surface that helps with ink integrity and ink adhesion. The transfer coating does not permanently bond to the base layer, thus allowing the ink layer to be transferred. The advantage of using a straight film construction is that the waterless tattoo can be inserted into food packs with out the need for over-wrapping.

In one embodiment, the base layer 110 is comprised of a clear 2 mil BOPP (Biaxially Oriented polypropylene) film available from Fasson Roll North America, 7670 Auburn Road Painsville Ohio 44077. This allows the image of the tattoo to show through the transparent film. In some embodiments, the transfer coating is made of NT19 available from Colorcon, 415 Moyer Blvd, P.O. Box 24 West Point, Pa. 19468. In some cases, the ink layer is a water base flexographic ink, available from Water Ink Technologies Canada Inc, 2500 Williams Parkway #50, Brampton Ontario, 16S 5M9. In some embodiments, the adhesive layer is an aqueous flexographic pressure sensitive adhesive, such as Raqua-Bond 5565 available from Rad-Cure Corporation, 9 Audrey Place, Fairfeild N.J. 07004. In some embodiments, the top layer is a silicone liner. The silicone liner is paper based in some cases and film based in other cases. This allows for printing of instructions on the back of the tattoo. In a preferred embodiment, the top layer is a 50# Machine finished coated liner available from Fasson Roll North America. In other embodiments, the base and the top layers are both made using a paper or thermal plastic substrate.

A 2-mil base layer stays flat when sheeted and is thin enough to contour to the surface to which it transferred. In other embodiments, both the top and the base layers are made of a thicker or thinner material.

FIG. 2 is a flowchart of a method of producing a tattoo. The method comprises four steps: applying a transfer coating to a base layer (Step 210); applying an ink layer to said transfer coating (Step 220); applying an adhesive layer to the ink layer (Step 230); and applying a top layer to the adhesive layer such that the top layer can be peeled off the adhesive layer (Step 240). The base layer is applied in such a manner that it is peelable off the tattoo after the adhesive layer is pressed onto a surface. In some embodiments, applying the ink layer comprises applying a plurality of ink layers of different colours.

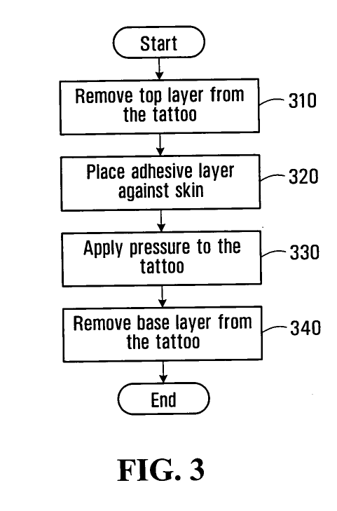

Embodiments of a tattoo according to the present invention can be easily applied by the user. FIG. 3 is a flowchart of a method of applying a tattoo made in accordance with an embodiment of the present invention. The first step is to remove the top layer of the tattoo (Step 310). This exposes the adhesive layer. The next step is to place the tattoo on a surface with the adhesive facing the surface (Step 320). If the surface on which the tattoo is to be placed is skin, the skin is preferably clean and oil free. The next step is to apply pressure to the tattoo (Step 330). At the next step the base layer is removed from the tattoo (Step 340). The base layer peels away from the transfer layer, leaving at least the ink layer of the tattoo on the surface. In some embodiments, the adhesive layer and ink layer remain on the surface. In some cases, the adhesive layer pulls the ink layer from the base layer. In other embodiments, the transfer coating also remains on the surface.

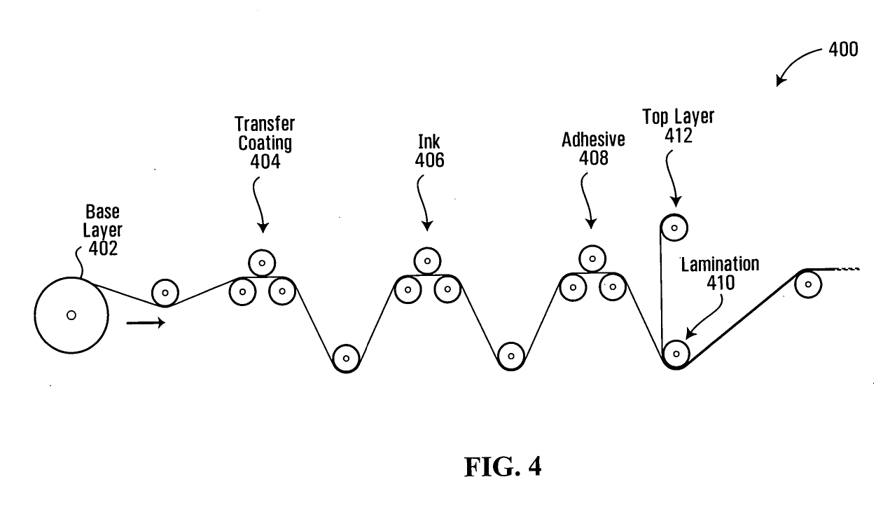

FIG. 4 is a schematic of a printing press 400 for producing a tattoo, in accordance with an embodiment of the present invention. The printing press 400 comprises at least four print stations: a transfer coating print station 404; at least one ink print station 406; an adhesive print station 408; and a top layer lamination station 410. In operation, a base layer 402 is fed through the printing press 400 starting at the transfer coating print station 404. The transfer coating print station 404 is for applying a transfer coating to the base layer 402 of the waterless tattoo in such a manner that the transfer coating is peelable from the base layer. The at least one ink print station 406 is for applying at least one ink layer to the transfer coating. In some embodiments, multiple colours of ink are applied by a plurality ink print stations. The adhesive layer print station 408 is for applying an adhesive layer to the ink layer. The top layer lamination station 410 is for applying a top layer 412 to the adhesive layer, the top layer being peelable from the adhesive layer.

In some embodiments, the printing press also has a die station for cutting the tattoo.

In an embodiment of the invention, a tattoo is produced using an eight colour flexographic printing press, such as the Webtron 750HQV. In some cases a 2 mil clear film which comes in a roll form is used as the base layer. The film travels through the press, and at a first print station, the transfer coating is applied. The film with the transfer coating next travels through four or five print stations, where water base flexograpghic inks are applied. In preferred embodiments, white ink is added as a last colour, so that it is the base colour once the tattoo is transferred. An adhesive is then applied at the seventh print station. After the adhesive is applied, a top silicone liner is applied protecting the ink and the adhesive. The fully constructed material then travels through a die station where it is cut to its final size. Then it travels down a conveyor to the end of the printing press.

In some embodiments, the printing press also comprises an image printing station for printing an image on the top layer. In some cases the image is text, such as instructions for how to use the tattoo. In other cases, the image applied to the top layer is a replication of the tattoo image.

The advantage of printing tattoos in accordance with the present invention on a printing press is that the whole product can be produced inline and the finished product comes off the conveyor. Other embodiments of the tattoo in accordance with the present invention can be produced using other printing methods such as offset, digital, silkscreen or gravure in sheet or web form.

What has been described is merely illustrative of the application of the principles of the invention. Other arrangements and methods can be implemented by those skilled in the art without departing from the spirit and scope of the present invention.

1. A tattoo comprising:
a base layer;
a transfer coating adhered to the base layer;
an ink layer adhered to the transfer coating;
an adhesive layer adhered to the ink layer; and
a top layer adhered to the adhesive layer, the top layer being peelable off the adhesive layer and the base layer being peelable off the tattoo if the adhesive layer is pressed onto a surface.

2. The tattoo according to claim 1, wherein the adhesive layer comprises a pressure sensitive adhesive.

3. The tattoo according to claim 1, wherein the adhesive layer comprises an aqueous flexographic pressure sensitive adhesive.

4. The tattoo according to claim 1, wherein the transfer coating is clear.

5. The tattoo according to claim 1, wherein the transfer coating is NT19.

6. The tattoo according to claim 1, wherein the base layer is a clear BOPP (Biaxially Oriented Polypropylene) film.

7. The tattoo according to claim 1, wherein the base layer has a thickness of 2 mil.

8. The tattoo according to claim 1, wherein the top layer is a silicone liner.

9. The tattoo of claim 1, wherein the ink layer is comprised of a plurality of different coloured inks.

10. The tattoo according to claim 1, wherein the ink is selected from the group consisting of: water based flexographic ink; solvent based flexographic ink; silkscreen ink; offset ink; and gravure ink.

11. The tattoo according to claim 1, wherein:
the adhesive layer comprises a pressure sensitive adhesive;
the transfer coating is clear;
the base layer is a clear BOPP (Biaxially Oriented Polypropylene) film; and
the top layer is a paper based silicone liner.

12. A method of producing a tattoo, the method comprising:
applying a transfer coating to a base layer;
applying an ink layer to the transfer coating;
applying an adhesive layer to the ink layer; and
applying a top layer to the adhesive layer such that the top layer can be peeled off the adhesive layer,
the base layer being peelable off the tattoo if the adhesive layer is pressed onto a surface.

13. The method of claim 12, wherein applying the ink layer comprises applying a plurality of ink layers of different colours.

14. The method of claim 12 using a printing press.

15. The method of claim 12 using at least one of a flexographic printing press; a silk screen press; an offset press; and a gravure press.

16. A printing press for producing a tattoo:
a transfer coating print station for applying a transfer coating to a base layer of the waterless tattoo, the transfer coating being peelable from the base layer;
at least one ink print station for applying at least one ink layer to the transfer coating;
an adhesive layer print station for applying an adhesive layer to the ink layer; and
a top layer lamination station for applying a top layer to the adhesive layer, the top layer being peelable from the adhesive layer.

17. The printing press of claim 16, further comprising a die station for cutting the tattoo.

18. The printing press of claim 16, wherein the ink print station applies at least one of water based flexographic ink; solvent based flexographic ink; silkscreen ink; offset ink; and gravure ink.

19. The printing press of claim 16, wherein the ink print station applies the ink using at least one of flexographic ink printing methods; silk screen technology; offset printing methods; and gravure printing methods.

20. The printing press of claim 16, further comprising an image printing station for printing an image on the top layer.
